(19) United States
(12) Patent Application Publication
(10) Pub. No.: US 2026/0124978 A1
(43) Pub. Date: May 7, 2026

(54) SYSTEMS FOR VEHICLES AND METHODS THEREFOR

(71) Applicant: GM GLOBAL TECHNOLOGY OPERATIONS LLC, Detroit, MI (US)

(72) Inventors: Minseok Jeon, Gimpo-si (KR); Alejandro Barrera, Cuauhtemoc (MX); Jintae Kim, Seodaemun-gu (KR)

(73) Assignee: GM GLOBAL TECHNOLOGY OPERATIONS LLC, Detroit, MI (US)

(21) Appl. No.: 18/934,813

(22) Filed: Nov. 1, 2024

(51) Int. Cl. B60N 3/06; B60N 2/32; B60N 2/64

(52) U.S. Cl. CPC B60N 3/063; B60N 2/32; B60N 2/64

(57) ABSTRACT

Systems and methods of operation thereof are provided for vehicles. The systems include a first portion configured to be secured in a fixed position relative to a body of a vehicle, wherein the first portion includes a first seat cushion configured to support an occupant seated thereon, and a second portion pivotably coupled relative to the first portion. The system is configured to transition between a primary configuration and a secondary configuration by pivoting the second portion relative to the first portion. The second portion includes a second seat cushion configured to support the occupant thereon while the system is arranged in the primary configuration. The second portion includes a footrest configured to support feet of the occupant while the system is arranged in the secondary configuration and while the occupant is seated on the first seat cushion.

### INTRODUCTION

The technical field generally relates to vehicle seats, and more particularly relates to a system for a vehicle seat that may be transitioned between different configurations to accommodate passengers of various heights.

Seats in vehicles are typically configured to accommodate an average sized adult occupant. As such, certain vehicle accessories such as child car seats and booster seats are commonly used to accommodate children. These accessories may be cumbersome to install, may require separate storage when not in use, and/or may complicate the overall seating arrangement within the vehicle.

Accordingly, there is an ongoing desire for systems and methods that promote comfort of passengers while seated in vehicles. Furthermore, other desirable features and characteristics of the present disclosure will become apparent from the subsequent detailed description and the appended claims, taken in conjunction with the accompanying drawings and the foregoing introduction.

### SUMMARY

A system is provided for accommodating occupants of various sizes in a vehicle. In one example, the system includes a first portion configured to be secured in a fixed position relative to a body of a vehicle, wherein the first portion includes a first seat cushion configured to support an occupant seated thereon, and a second portion pivotably coupled relative to the first portion. The system is configured to transition between a primary configuration and a secondary configuration by pivoting the second portion relative to the first portion. The second portion includes a second seat cushion configured to support the occupant thereon while the system is arranged in the primary configuration. The second portion includes a footrest configured to support feet of the occupant while the system is arranged in the secondary configuration and while the occupant is seated on the first seat cushion.

In various examples, the first seat cushion of the system may include a central region and side regions on opposite sides of the central region. The central region extends further toward a front of the vehicle than the side regions. The second seat cushion includes a recess configured to receive the central region while the system is arranged in the primary configuration.

In various examples, the system may include a second footrest configured to be exposed while the system is arranged in the secondary configuration. The second footrest may be disposed in a position above the footrest while the system is arranged in the secondary configuration.

In various examples, the system may be configured to transition to an intermediate configuration between the primary configuration and the secondary configuration by pivoting the second portion relative to the first portion. The second portion may be in a first position in the primary configuration, in a second position in the secondary configuration, and a third position in the intermediate configuration, wherein the third position is pivotally between the first position and the second position about an axis of rotation. In various examples, the system may include an adjustment device configured to transition the system between the primary configuration, the intermediate configuration, and the secondary configuration. The adjustment device may be configured to releasably lock the second portion relative to the first portion while the system is arranged in in the primary configuration, the intermediate configuration, and/or the secondary configuration.

In various examples, the first portion of the system may include a first rigid frame and the second portion may include a second rigid frame. The first rigid frame and the second rigid frame may be pivotably coupled at a pivoting joint between the first portion and the second portion. In various examples, at least a portion of the pivoting joint may be defined by a flexible hinge.

In various examples, the system may include a rigid material disposed on the footrest.

In various examples, the first portion and the second portion of the system may be components of a bench-type seat of the vehicle. In various examples, the first portion and the second portion may be configured to define a middle seat between two adjacent seat cushions while the system is arranged in the primary configuration.

A method is provided for operating a system within a vehicle. In one example, the method includes transitioning the system from a primary configuration to a secondary configuration, and transitioning the system from the secondary configuration to the primary configuration. The system includes a first portion secured in a fixed position relative to a body of the vehicle and a second portion pivotably coupled relative to the first portion. A first seat cushion of the first portion and a second seat cushion of the second portion in combination are configured to support an occupant seated thereon while in the primary configuration. Transitioning the system from the primary configuration to the secondary configuration includes pivoting the second portion relative to the first portion to expose a footrest configured to support feet of the occupant while the occupant is seated on the first seat cushion. Transitioning the system from the secondary configuration to the primary configuration includes pivoting the second portion relative to the first portion to conceal the footrest.

In various examples, transitioning the system from the secondary configuration to the primary configuration may include disposing a central region of the first seat cushion within a recess of the second seat cushion. The central region may extend further toward a front of the vehicle than side regions on opposite sides of the first seat cushion.

In various examples, transitioning the system from the primary configuration to the secondary configuration may include exposing a second footrest disposed in a position above the footrest while the system is arranged in the secondary configuration.

In various examples, the method may include transitioning the system to an intermediate configuration by pivoting the second portion relative to the first portion. The second portion may be in a first position in the primary configuration, in a second position in the secondary configuration, and a third position in the intermediate configuration. The third position may be pivotally between the first position and the second position about an axis of rotation. In various examples, the method may include using an adjustment device to transition the system between the primary configuration, the intermediate configuration, and the secondary configuration. The method may include releasably locking the second portion in the first position, the second position, and/or the third position while the system is arranged in the primary configuration, the intermediate configuration, and the secondary configuration, respectively.

In various examples, the first portion and the second portion of the method are components of a bench-type seat of the vehicle.

A vehicle is provided that, in one example, includes at least one seat secured within the vehicle that includes a system having a first portion configured to be secured in a fixed position relative to a body of the vehicle, a second portion pivotably coupled relative to the first portion, and an adjustment device. The first portion includes a first seat cushion configured to support an occupant seated thereon. The system is configured to transition between a primary configuration, a secondary configuration, and at least one intermediate configuration by pivoting the second portion relative to the first portion. The second portion includes a second seat cushion configured to support the occupant thereon while the system is arranged in the primary configuration. The second portion includes a footrest configured to support feet of the occupant while the system is arranged in the secondary configuration and while the occupant is seated on the first seat cushion. The adjustment device is configured to transition the system between the primary configuration, the secondary configuration, and the at least one intermediate configuration. The adjustment device is configured to releasably lock the second portion in a first position while the system is arranged in the primary configuration, in a second position while the system is arranged in the secondary configuration, and in a third position while the system is arranged in the at least one intermediate configuration, wherein the third position is pivotally between the first position and the second position about an axis of rotation.

In various examples, the first portion of the vehicle may include a first rigid frame and the second portion of the vehicle may include a second rigid frame. The first rigid frame and the second rigid frame may be pivotably coupled at a pivoting joint between the first portion and the second portion. The pivoting joint may include a flexible hinge. The second portion may include a rigid material disposed on the footrest.

In various examples, the first portion and the second portion of the vehicle may be components of a bench-type seat of the vehicle. In various examples, the first portion and the second portion may be configured to define a middle seat between two adjacent seat cushions while the system is arranged in the primary configuration.

### BRIEF DESCRIPTION OF THE DRAWINGS

The exemplary embodiments will hereinafter be described in conjunction with the following drawing figures, wherein like numerals denote like elements, and wherein:

FIG. 1 is a functional block diagram of a vehicle that includes a seat cushion system in accordance with an example;

FIG. 2 is an isolated, perspective view of bench-type seat having the seat cushion system of FIG. 1 in accordance with an example, wherein the seat cushion system is arranged in a primary configuration;

FIG. 3 is an isolated, perspective view of the bench-type seat having the seat cushion system of FIGS. 1 and 2 in accordance with an example, wherein the seat cushion system is arranged in a secondary configuration;

FIG. 4 is an enlarged, perspective view of the seat cushion system of FIGS. 1-3 while arranged in a secondary configuration in accordance with an example;

FIG. 5 is an enlarged, perspective view of the seat cushion system of FIGS. 1-4 while arranged in an intermediate configuration in accordance with an example;

FIG. 6 is an enlarged, perspective view of the seat cushion system of FIGS. 1-5 while arranged in an intermediate configuration in accordance with an example, wherein a cushion frame of the seat cushion system is represented;

FIG. 7 is an enlarged, perspective view of the seat cushion system of FIGS. 1-6 while arranged in an intermediate configuration in accordance with an example, wherein certain portions of the seat cushion system are omitted to show the cushion frame of FIG. 6;

FIGS. 8 and 9 include exploded, perspective views of an adjustment device of the seat cushion system of FIGS. 1-7 in accordance with an example;

FIG. 10 is a partial cross-sectional view of the adjustment device of FIGS. 8 and 9 in accordance with an example;

FIG. 11 is an isolated, perspective view of the bench-type seat of FIGS. 1-7 arranged in the primary configuration with a first occupant seated thereon in accordance with an example;

FIG. 12 is an isolated, perspective view of the bench-type seat of FIGS. 1-7 arranged in the secondary configuration with a second occupant seated thereon in accordance with an example;

FIG. 13 is an isolated, perspective view of the bench-type seat of FIGS. 1-7 arranged in the secondary configuration with a third occupant seated thereon in accordance with an example; and

FIG. 14 is a flowchart illustrating a method for operating a seat cushion system of a vehicle in accordance with an example.

### DETAILED DESCRIPTION

The following detailed description is merely exemplary in nature and is not intended to limit the application and uses. Furthermore, there is no intention to be bound by any expressed or implied theory presented in the preceding introduction or the following detailed description.

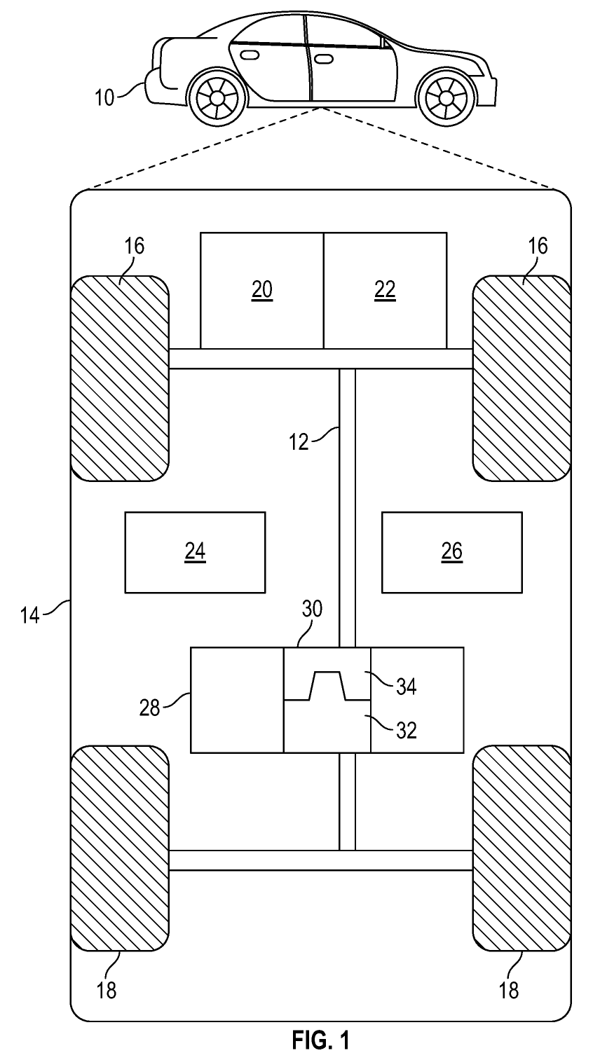

FIG. 1 illustrates a vehicle 10 that includes a seat cushion system 30 configured to accommodate passengers of various heights, according to an example. In certain examples, the vehicle 10 comprises an automobile. In various examples, the vehicle 10 may be any one of a number of different types of automobiles, such as, for example, a sedan, a wagon, a truck, or a sport utility vehicle (SUV), and may be two-wheel drive (2WD) (i.e., rear-wheel drive or front-wheel drive), four-wheel drive (4WD) or all-wheel drive (AWD), and/or various other types of vehicles or mobile platforms in certain examples.

As depicted in FIG. 1, the exemplary vehicle 10 generally includes a chassis 12, a body 14, front wheels 16, and rear wheels 18. The body 14 is arranged on the chassis 12 and substantially encloses components of the vehicle 10. The body 14 and the chassis 12 may jointly form a frame. The wheels 16, 18 are each rotationally coupled to the chassis 12 near a respective corner of the body 14. The vehicle 10 may include a propulsion system 20 and a transmission system 22. The propulsion system 20 includes an engine and/or motor such as an internal combustion engine (e.g., a gasoline or diesel fueled combustion engine), an electric motor (e.g., a 3-phase AC motor), or a hybrid system that includes more than one type of engine and/or motor. The transmission system 22 is configured to transmit power from the propulsion system 20 to the wheels 16, 18 according to selectable speed ratios. According to various examples, the transmission system 22 may include a step-ratio automatic transmission, a continuously-variable transmission, or other appropriate transmission.

The vehicle 10 may include front seats 24, 26 and one or more rear seats 28 each configured to support an occupant of the vehicle 10 sitting thereon. In this example, the vehicle 10 includes two rows of seats; however, the vehicle 10 may include one or more additional rows of seats such as a third row. Each of the seats 24, 26, 28 may include a frame (not shown) secured to a floor of the vehicle 10, a seat base or seat cushion coupled to the frame, a seatback secured at a lower end thereof to the seat cushion and/or the frame, and a headrest secured to an upper end of the seatback. The seat cushion may be configured to support a rear and/or thighs of the occupant seated thereon, the seatback may be configured to support the occupant’s back while seated on the seat cushion, and the headrest may be configured to support the occupant’s head. The seats 24, 26, 28 may include various components that provide for adjustment thereof, such as systems for adjusting a height of the seats 24, 26, 28 relative to the vehicle floor, a recline angle of the seatback, lumbar support, and a height of the headrest relative to an upper end of the seatback. In this example, the seat cushion system 30 is included in the rear seat 28. Alternatively, or in addition, any of the seats 24, 26, 28 or additional seats (not shown) may include the seat cushion system 30.

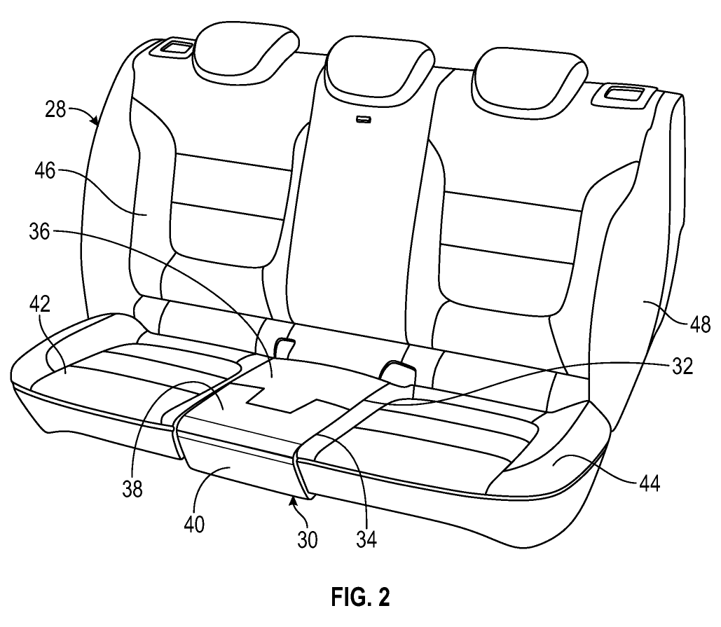

Referring now to FIGS. 2-5 and with continued reference to FIG. 1, the rear seat 28 is configured as a bench-type seat, specifically a 60/40 split bench seat configured to seat up to three passengers. More specifically, the rear seat 28 includes a first seat cushion 42, a second seat cushion 44, and the seat cushion system 30 therebetween. A first seatback 46 is pivotably coupled relative to the first seat cushion 42 and a second seatback 48 is pivotably coupled relative to the second seat cushion 44 and the seat cushion system 30. As such, the seat cushion system 30 defines a seat base or seat cushion for a middle seat of the rear seat 28. Notably, configurations other than represented in the drawings are possible. For example, the rear seat 28 may be a 40/20/40 split bench seat or a pair of separate captain’s seats.

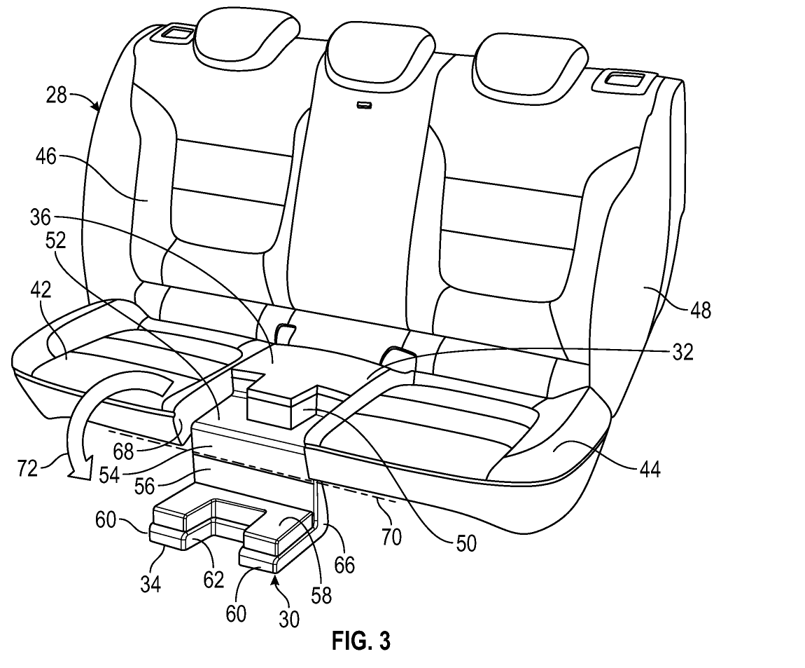

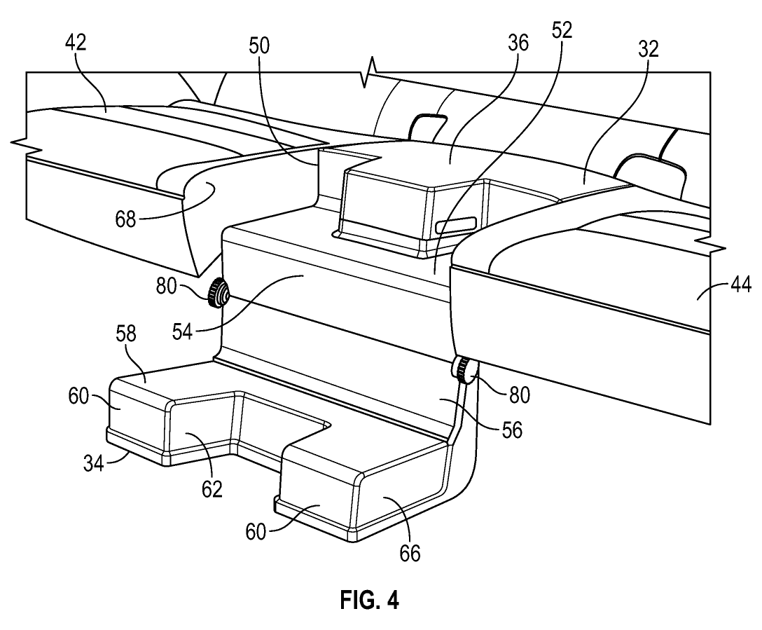

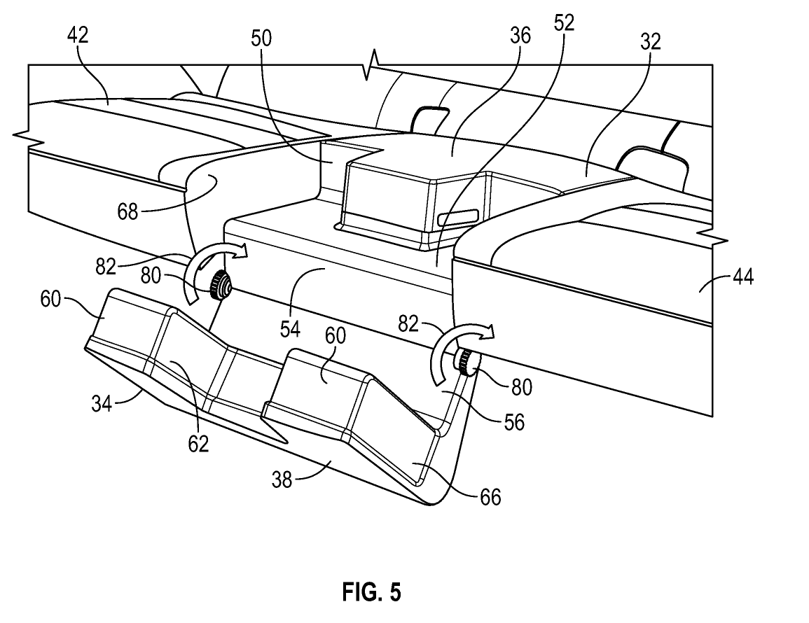

The seat cushion system 30 includes a rear portion 32 and a front portion 34 wherein the rear portion 32 is disposed further toward a rear of the vehicle 10 and the front portion 34 is disposed further toward a front of the vehicle 10. In this example, the rear portion 32 may be secured in a fixed position relative to the frame of the vehicle 10 and/or relative to the first seat cushion 42 and the second seat cushion 44. The front portion 34 is pivotable relative to the rear portion 32. In this example, the front portion 34 is pivotably coupled to the rear portion 32 with a pivoting joint; however, the front portion 34 may alternatively be separate from the rear portion 32 and pivotably coupled to, for example, a frame of the rear seat 28. With this arrangement, the front portion 34 may be pivoted relative to the rear portion 32 about an axis of rotation 70 to selectively transition the seat cushion system 30 between a primary configuration (e.g., as shown in FIG. 2) and a secondary configuration (e.g., as shown in FIGS. 3 and 4). A first pivoting direction for the transition from the primary configuration to the secondary configuration is represented in FIG. 3 by a first arrow 72, and a second pivoting direction for the transition from the secondary configuration to the primary configuration is represented in FIG. 5 by second arrows 82.

The rear portion 32 includes a rear seat cushion 36 and the front portion 34 includes a front seat cushion 38 and a leg cushion 40. While the seat cushion system 30 is in the primary configuration, the rear seat cushion 36 and the front seat cushion 38 may define upper exterior surfaces of the seat cushion system 30 and the leg cushion 40 may define front exterior surfaces of the seat cushion system 30. In some examples, while the seat cushion system 30 is in the primary configuration, adjacent exterior surfaces of the rear seat cushion 36 and the front seat cushion 38 may be aligned and/or flush or otherwise contoured to define a single, combined seat cushion. In some examples, the combined seat cushion may have a substantially similar depth (front-to-rear direction of the vehicle 10) as the first seat cushion 42 and the second seat cushion 44. While the seat cushion system 30 is in the primary configuration, the leg cushion 40 may be substantially aligned and/or flush with front exterior surfaces of the first seat cushion 42 and the second seat cushion 44. In some examples, while the seat cushion system 30 is in the primary configuration, the rear seat cushion 36, the front portion 34, and the leg cushion 40 may be contoured in a manner to provide an appearance and/or functionality similar to a middle seat of a comparable, existing 60/40 split bench seat that does not include the seat cushion system 30, for example, that includes a single integral body.

In this example, the rear portion 32 and the front portion 34 may include inner surfaces that are concealed while the seat cushion system 30 is in the seated configuration and that are exposed while the seat cushion system 30 is in the secondary configuration. The inner surfaces of the rear portion 32 may include rear sidewalls 50, a rear footrest 52, and a rear connection wall 54. The inner surfaces of the front portion 34 may include a front connection wall 56, the front footrest 58, front walls 60, front inner walls 62, and front sidewalls 66. While the seat cushion system 30 is in the seated configuration, the front connection wall 56 may be in contact with or adjacent to the rear connection wall 54, the front footrest 58 may be in contact with or adjacent to the rear footrest 52, the front walls 60 and the front inner walls 62 may be in contact with or adjacent to the rear sidewalls 50, and the front sidewalls 66 may be in contact with or adjacent to side walls 68 of the first seat cushion 42 and the second seat cushion 44. In this example, the rear connection wall 54 and the front connection wall 56 are coupled at adjacent edges thereof (e.g., along the axis of rotation 70) to define the pivoting joint of the seat cushion system 30. In some examples, the rear sidewalls 50 may include a relatively hard surface or material configured to reduce friction with the second portion and/or provide support for the rear seat cushion 36 while the seat cushion system 30 is arranged in the secondary configuration.

While the seat cushion system 30 is arranged in the secondary configuration, the front portion 34 may be disposed in a position below the height of the rear portion 32 and/or the first and second seat cushions 42, 44. For example, the front connection wall 56 may hang from the rear connection wall 54, and the front footrest 58 may be cantilevered toward the front of the vehicle 10 from the front connection wall 56. In this position, the front footrest 58 may be configured to support feet of the occupant while the occupant is seated on the rear seat cushion 36. In some examples, while the seat cushion system 30 is in the secondary configuration, the rear connection wall 54 and the front connection wall 56 may be substantially aligned in a common geometric plane.

In some examples, the seat cushion system 30 may be configured to be transitioned to one or more intermediate configurations pivotably between the seated configuration and the secondary configuration. For example, FIG. 5 represents an example wherein the seat cushion system 30 is arranged in an intermediate configuration wherein the rear connection wall 54 and the front connection wall 56 define an angle therebetween of between 90 and 179 degrees, such as between about 130 and 175 degrees, such as between about 150 and 165 degrees. In some examples, the rear connection wall 54 and/or the front connection wall 56 may be configured to support an occupant’s feet and/or legs while the seat cushion system 30 is arranged in one or more intermediate configurations.

The seat cushion system 30 may include a cushion frame configured to maintain a rigid structure of the front portion 34 while the seat cushion system 30 is arranged in the secondary configuration and the one or more intermediate configurations, and support the front portion 34 with or without a load applied thereto (e.g., an occupant’s feet) while the seat cushion system 30 is arranged in the secondary configuration and the one or more intermediate configurations. In some examples, the cushion frame may be embedded within the seat cushion system 30, rather than defining an exterior surface, such that the cushion frame does not interfere with the comfort and/or functionality of the other components of the seat cushion system 30, such as the front seat cushion 38.

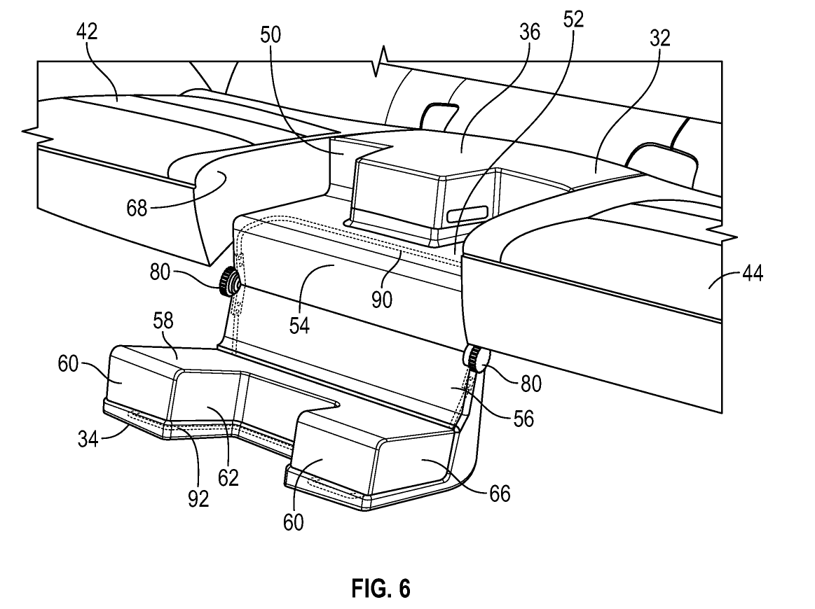

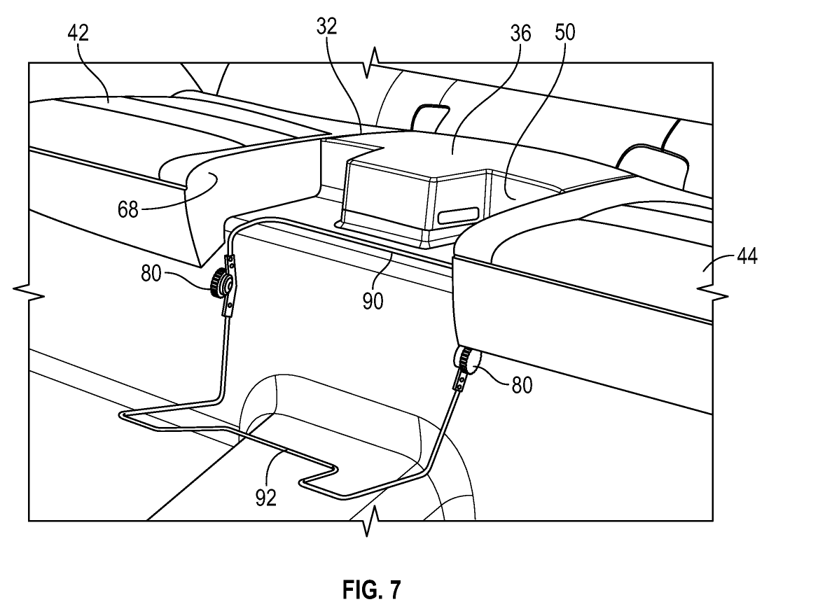

FIGS. 6 and 7 represent an exemplary cushion frame that includes a first rigid frame 90 embedded in the rear portion 32 and a second rigid frame 92 embedded in the front portion 34. In FIG. 7, portions of the seat cushion system 30 are omitted to more clearly show the cushion frame. In this example, the first rigid frame 90 includes a first rod or wire that extends into the rear portion 32 to an extent sufficient to anchor the front portion 34 to the rear portion 32. The second rigid frame 92 includes a second rod or wire that extends through the front portion 34 in a manner that provides local rigidity and strength. The first rigid frame 90 and the second rigid frame 92 may be pivotally coupled at ends of the pivoting joint by a pair of adjustment devices 80 (discussed in more detail below). In this example, the cushion frame does not include rigid rods or wires or other rigid bodies extending along or passing through the pivoting joint (i.e., axis of rotation 70). Instead, the pivoting joint only includes the adjustment devices 80 at ends thereof and a flexible hinge (e.g., formed of a fabric or other flexible material) extending therebetween. In some examples, use of the flexible hinge may promote the durability of the pivoting joint and/or promote user comfort.

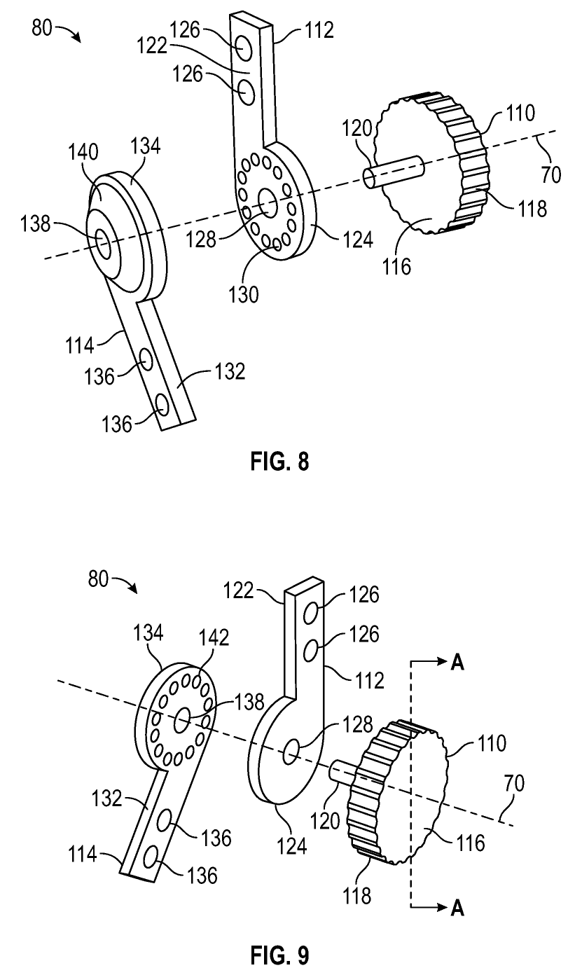

The seat cushion system 30 may include at least one adjustment device configured to transition the seat cushion system 30 between the primary configuration, the intermediate configuration(s), and the secondary configuration. In some examples, the adjustment device may be configured to releasably lock the front portion 34 in fixed positions while the seat cushion system 30 is arranged in the primary configuration, the intermediate configuration(s), and the secondary configuration. Various mechanisms may be used for the adjustment device including manual and motorized adjustment mechanisms. For example, FIGS. 4-7 represent the seat cushion system 30 as including the pair of adjustment devices 80 functionally coupled at opposite ends of the pivoting joint along the axis of rotation 70. In this example, the adjustment devices 80 are manually operated mechanisms that include a knob 110, a rear support member 112, and a front support member 114 as represented in FIGS. 8-10.

The knob 110 may include a disk-shaped body 116, a textured surface 118 about a perimeter of the body 116 configured as a finger grip, and a shaft extending from a center of the body 116. The rear support member 112 may include a disk-shaped, rear central member 124 and a rear elongated member 122 extending therefrom. In some examples, the rear elongated member 122 may have a longitudinal axis aligned with a geometric tangent of a perimeter of the rear central member 124. The rear central member 124 may include a rear bore 128 through a center thereof, and the rear elongated member 122 may include one or more mounting holes 126 therethrough. The rear central member 124 may include a plurality of protrusions 130 spaced apart along a circular path on a side thereof. In this example, each of the protrusions 130 have a semispherical shape; however, other shapes are possible. The front support member 114 may include a disk-shaped, front central member 134 and a front elongated member 132 extending therefrom. In some examples, the front elongated member 132 may have a longitudinal axis aligned with a geometric tangent of a perimeter of the front central member 134. The front central member 134 may include a front bore 138 through a center thereof, and the front elongated member 132 may include one or more mounting holes 136 therethrough. The front central member 134 may include a plurality of recesses 142 spaced apart along a circular path on a side thereof. In this example, each of the recesses 142 have a semispherical shape; however, other shapes are possible. In some examples, the front central member 134 may include a bevel (or chamfered) region 140 on a side opposite the plurality of recesses 142.

With this arrangement, the knob 110, a rear support member 112, and a front support member 114 may be coupled by disposing the shaft 120 extending from the knob 110 through the rear bore 128 and the front bore 138, wherein the side of the rear central member 124 having the plurality of protrusions 130 is facing the side of the front central member 134 having the plurality of recesses 142.

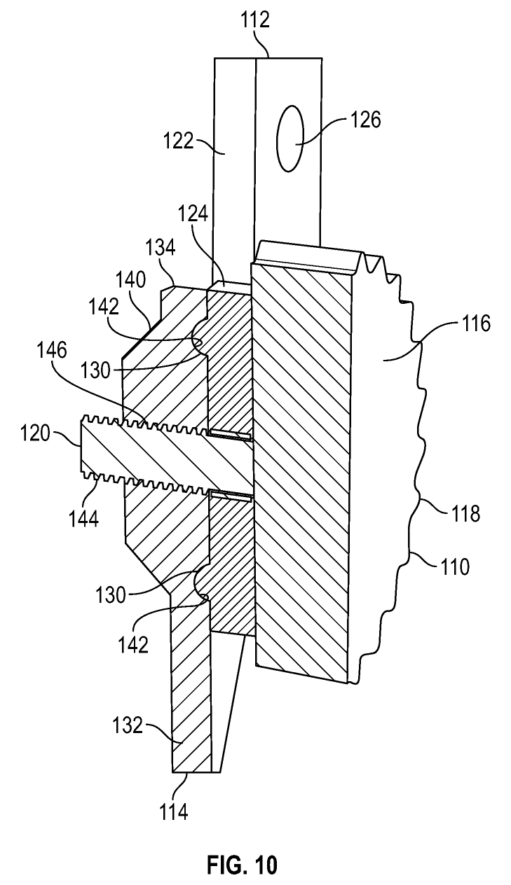

At least a distal end of the shaft 120 may be configured to threadedly couple with at least a portion of the front bore 138 corresponding to the bevel region 140. For example, FIG. 10 represents a distal portion of the shaft 120 having first threads 144 thereon and the front bore 138 having corresponding second threads 146 thereon. With such an arrangement, the knob 110 may be rotated relative to the front central member 134 to apply and/or release a clamping force on the rear central member 124. In this manner, the clamping force may be released or reduced to allow for rotation of the rear support member 112 relative to the front support member 114. Once the rear support member 112 has been positioned as desired relative to the front support member 114, the clamping force may be applied to maintain the relative position. While the clamping force is applied, each of the plurality of protrusions 130 may be disposed within a corresponding one of the plurality of recesses 142 to provide additional resistance to rotation.

The rear support member 112 may be secured to the rear portion 32 and the front support member 114 may be secured to the front portion 34. For example, the rear support member 112 may be coupled to the first rigid frame 90 with fasteners disposed through the one or more mounting holes 126 of the rear elongated member 122 and corresponding mounting holes of the first rigid frame 90. Similarly, the front support member 114 may be coupled to the second rigid frame 92 with fasteners disposed through the one or more mounting holes 136 of the front elongated member 132 and corresponding mounting holes of the second rigid frame 92.

An interface between the rear portion 32 and the front portion 34 while the of the seat cushion system 30 is arranged in the primary configuration may have various shapes. In this example, the interface is defined by the rear sidewalls 50, the front walls 60, and the front inner walls 62. In particular, the rear seat cushion 36 includes a central region that extends further toward a front of the vehicle 10 than side regions on opposite sides thereof, and the front seat cushion 38 includes a recess configured (defined by the front inner walls 62) to receive the central region while the of the seat cushion system 30 is disposed in the primary configuration. This structure may promote user comfort. In some examples, this structure may promote other functions of the seat cushion system 30. For example, the rear footrest 52 may be configured to support the occupant’s feet while the occupant is seated on the rear seat cushion 36 and while the of the seat cushion system 30 is arranged in the secondary configuration. In particular, the rear footrest 52 is exposed and disposed in a position above the front footrest 58 while the of the seat cushion system 30 is arranged in the secondary configuration. In some examples, it may be more comfortable for the occupant to place their feet on the rear footrest 52 rather than the front footrest 58, especially if the occupant is relatively small and their legs do not reach the front footrest 58. In such examples, providing additional space on sides of the central region of the rear seat cushion 36 may provide additional room for the occupant’s feet.

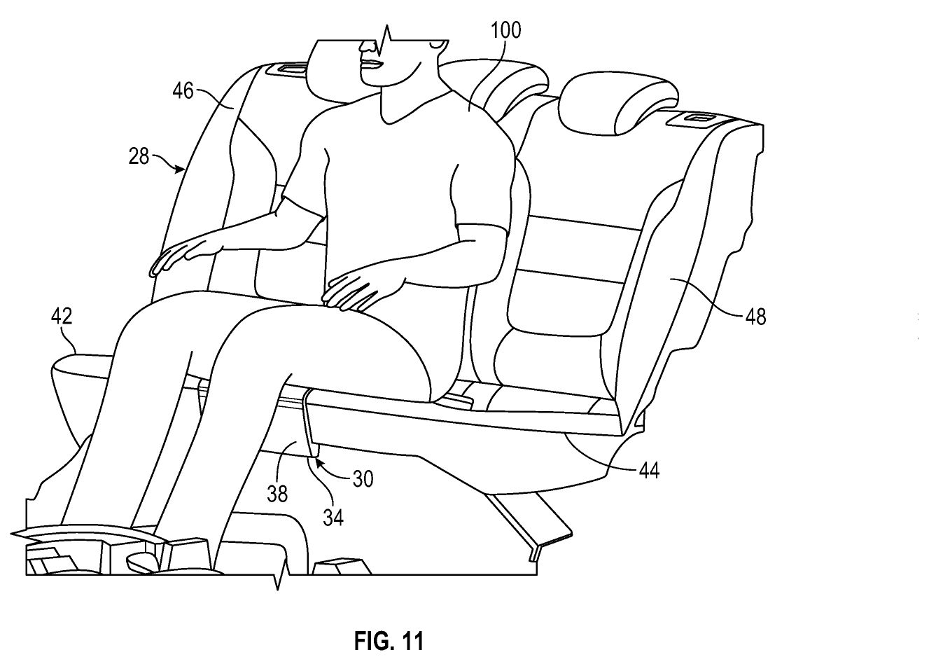

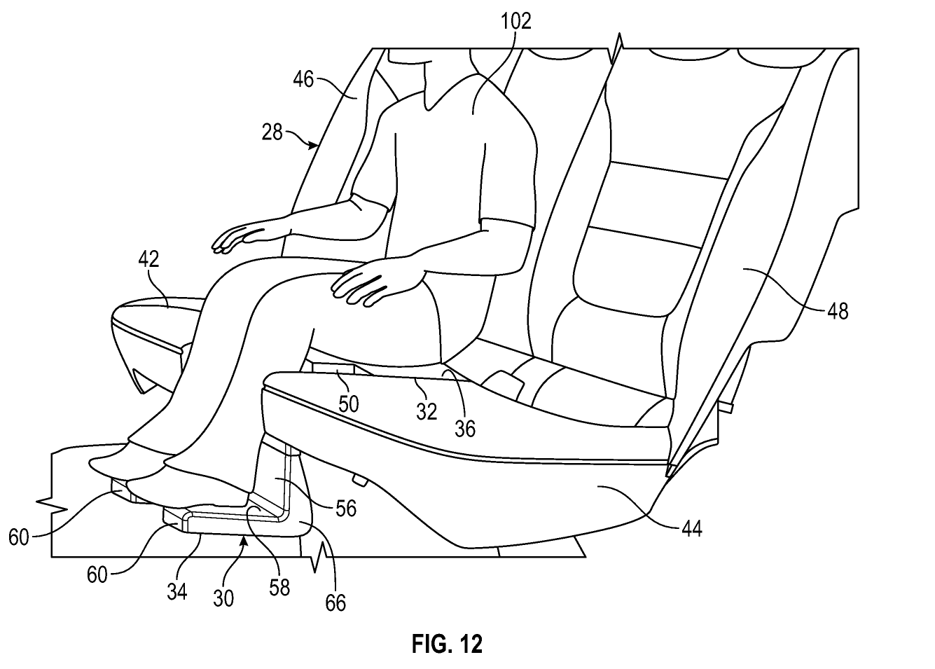

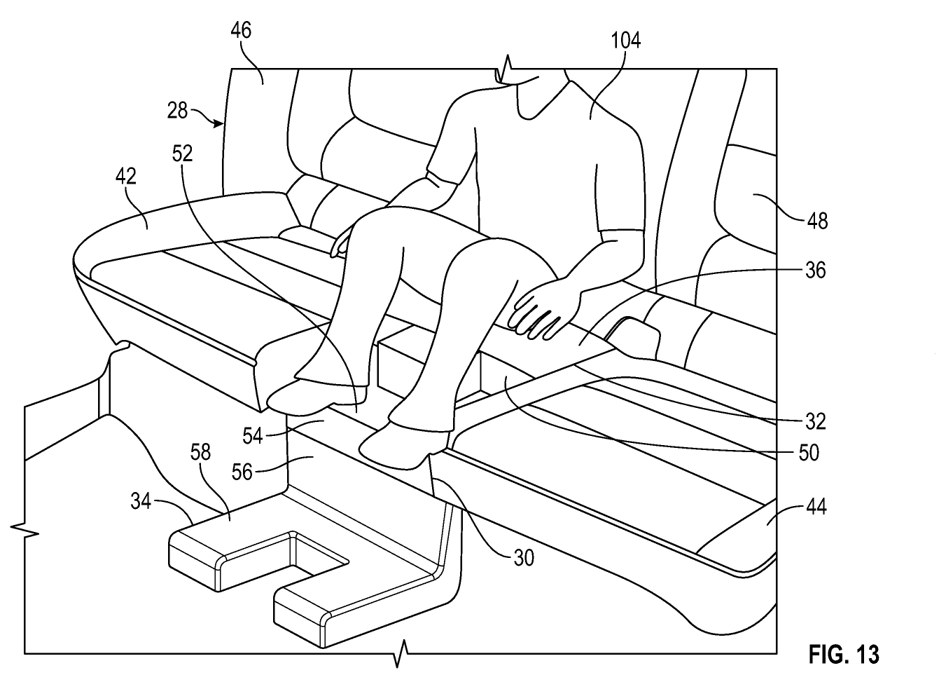

FIGS. 11-13 illustrate nonlimiting examples of first, second, and third occupants 100, 102, 104 using the seat cushion system 30. For convenience of the following description, the first occupant 100 has a first height, the second occupant 102 has a second height, and the third occupant 104 has a third height, wherein the first height is greater that the second height, and the second height is greater than the third height. In FIG. 11, the seat cushion system 30 is arranged in the primary configuration and the first occupant 100 is seated on the rear and front seat cushions 36, 38. In this example, the first occupant 100 is sufficiently tall such that their feet may comfortably rest on a floor of the vehicle 10. In FIG. 12, the seat cushion system 30 is arranged in the secondary configuration and the second occupant 102 is seated on the rear seat cushion 36 and has their feet resting on the front footrest 58. In this example, the second occupant 102 is not tall enough to comfortably rest their feet on the floor of the vehicle 10, but is sufficiently tall such that their feet may comfortably rest on the front footrest 58. In FIG. 13, the seat cushion system 30 is arranged in the secondary configuration and the third occupant 104 is seated on the rear seat cushion 36 and has their feet resting on the rear footrest 52. In this example, the third occupant 104 is not tall enough to comfortably rest their feet on the floor of the vehicle 10, and either is not tall enough to comfortably rest their feet on the front footrest 58 or simply prefers to rest their feet on the rear footrest 52.

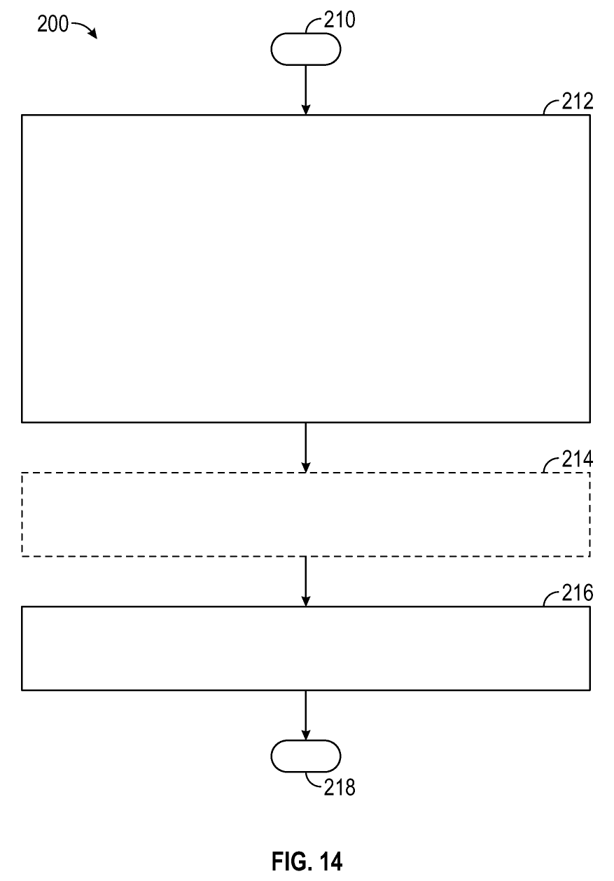

With reference now to FIG. 14 and with continued reference to FIGS. 1-13, a flowchart provides a method 200 for operating the of the seat cushion system 30, in accordance with various examples. As can be appreciated in light of the disclosure, the order of operation within the method 200 may not limited to the sequential execution as illustrated in FIG. 14, but may be performed in one or more varying orders as applicable and in accordance with the present disclosure.

In one example, the method 200 may start at 210. At 212, the method 200 may include transitioning the seat cushion system 30 within the vehicle 10 from the primary configuration to the secondary configuration by pivoting the front portion 34 relative to the rear portion 32 to expose the front footrest 58 to support the feet of the occupant while the occupant is seated on the rear seat cushion 36. At 214, the method 200 may optionally include transitioning the of the seat cushion system 30 from the primary configuration, the secondary configuration, or another intermediate configuration to the intermediate configuration that is between the primary configuration and the secondary configuration. At 216, the method 200 may include transitioning the seat cushion system 30 either from the secondary configuration or the intermediate configuration to the primary configuration by pivoting the front portion 34 relative to the rear portion 32 to conceal the front footrest 58. The method 200 may end at 218.

The systems and methods disclosed herein provide various benefits over certain existing systems and methods. For example, the seat cushion system 30 is configured to be arranged in various configurations to accommodate occupants of various heights. This functionality may reduce the need for certain vehicle accessories such as child car seats and booster seats which may be cumbersome to install, may require separate storage, and/or may complicate the overall seating arrangement within the vehicle 10. In contrast, the seat cushion system 30 may an integrated, seamless, efficient, and user-friendly solution to optimize the seating comfort and safety of passengers having various body sizes.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A system, comprising:
a first portion configured to be secured in a fixed position relative to a body of a vehicle, the first portion including a first seat cushion configured to support an occupant seated thereon; and
a second portion pivotably coupled relative to the first portion,
wherein the system is configured to transition between a primary configuration and a secondary configuration by pivoting the second portion relative to the first portion, the second portion including a second seat cushion configured to support the occupant thereon while the system is arranged in the primary configuration, the second portion including a footrest configured to support feet of the occupant while the system is arranged in the secondary configuration and while the occupant is seated on the first seat cushion.

2. The system of claim 1, wherein the first seat cushion includes a central region and side regions on opposite sides of the central region, wherein the central region extends further toward a front of the vehicle than the side regions, wherein the second seat cushion includes a recess configured to receive the central region while the system is arranged in the primary configuration.

3. The system of claim 1, further comprising a second footrest configured to be exposed while the system is arranged in the secondary configuration, wherein the second footrest is disposed in a position above the footrest while the system is arranged in the secondary configuration.

4. The system of claim 1, wherein the system is configured to transition to an intermediate configuration between the primary configuration and the secondary configuration by pivoting the second portion relative to the first portion, wherein the second portion is in a first position in the primary configuration, in a second position in the secondary configuration, and a third position in the intermediate configuration, wherein the third position is pivotally between the first position and the second position about an axis of rotation.

5. The system of claim 4, further comprising an adjustment device configured to transition the system between the primary configuration, the intermediate configuration, and the secondary configuration, wherein the adjustment device is configured to releasably lock the second portion relative to the first portion while the system is arranged in in the primary configuration, the intermediate configuration, and/or the secondary configuration.

6. The system of claim 1, wherein the first portion includes a first rigid frame and the second portion includes a second rigid frame, wherein the first rigid frame and the second rigid frame are pivotably coupled at a pivoting joint between the first portion and the second portion.

7. The system of claim 6, wherein at least a portion of the pivoting joint is defined by a flexible hinge.

8. The system of claim 1, further comprising a rigid material disposed on the footrest.

9. The system of claim 1, wherein the first portion and the second portion are components of a bench-type seat of the vehicle.

10. The system of claim 9, wherein the first portion and the second portion are configured to define a middle seat between two adjacent seat cushions while the system is arranged in the primary configuration.

11. A method, comprising:
transitioning a system within a vehicle from a primary configuration to a secondary configuration, the system including a first portion secured in a fixed position relative to a body of the vehicle and a second portion pivotably coupled relative to the first portion, wherein a first seat cushion of the first portion and a second seat cushion of the second portion in combination are configured to support an occupant seated thereon while in the primary configuration, wherein transitioning the system from the primary configuration to the secondary configuration includes pivoting the second portion relative to the first portion to expose a footrest configured to support feet of the occupant while the occupant is seated on the first seat cushion; and
transitioning the system from the secondary configuration to the primary configuration by pivoting the second portion relative to the first portion to conceal the footrest.

12. The method of claim 11, wherein transitioning the system from the secondary configuration to the primary configuration includes disposing a central region of the first seat cushion within a recess of the second seat cushion, wherein the central region extends further toward a front of the vehicle than side regions on opposite sides of the first seat cushion.

13. The method of claim 11, wherein transitioning the system from the primary configuration to the secondary configuration includes exposing a second footrest disposed in a position above the footrest while the system is arranged in the secondary configuration.

14. The method of claim 11, further comprising transitioning the system to an intermediate configuration by pivoting the second portion relative to the first portion, wherein the second portion is in a first position in the primary configuration, in a second position in the secondary configuration, and a third position in the intermediate configuration, wherein the third position is pivotally between the first position and the second position about an axis of rotation.

15. The method of claim 14, further comprising using an adjustment device to transition the system between the primary configuration, the intermediate configuration, and the secondary configuration, the method including releasably locking the second portion in the first position, the second position, and/or the third position while the system is arranged in the primary configuration, the intermediate configuration, and the secondary configuration, respectively.

16. The method of claim 11, wherein the first portion and the second portion are components of a bench-type seat of the vehicle.

17. A vehicle comprising at least one seat secured within the vehicle that includes a system having:
a first portion configured to be secured in a fixed position relative to a body of the vehicle, the first portion including a first seat cushion configured to support an occupant seated thereon;
a second portion pivotably coupled relative to the first portion,
wherein the system is configured to transition between a primary configuration, a secondary configuration, and at least one intermediate configuration by pivoting the second portion relative to the first portion, the second portion including a second seat cushion configured to support the occupant thereon while the system is arranged in the primary configuration, the second portion including a footrest configured to support feet of the occupant while the system is arranged in the secondary configuration and while the occupant is seated on the first seat cushion; and
an adjustment device configured to transition the system between the primary configuration, the secondary configuration, and the at least one intermediate configuration,
wherein the adjustment device is configured to releasably lock the second portion in a first position while the system is arranged in the primary configuration, in a second position while the system is arranged in the secondary configuration, and in a third position while the system is arranged in the at least one intermediate configuration, wherein the third position is pivotally between the first position and the second position about an axis of rotation.

18. The vehicle of claim 17, wherein the first portion includes a first rigid frame and the second portion includes a second rigid frame, wherein the first rigid frame and the second rigid frame are pivotably coupled at a pivoting joint between the first portion and the second portion, wherein the pivoting joint includes a flexible hinge, wherein the second portion includes a rigid material disposed on the footrest.

19. The vehicle of claim 17, wherein the first portion and the second portion are components of a bench-type seat of the vehicle.

20. The vehicle of claim 19, wherein the first portion and the second portion are configured to define a middle seat between two adjacent seat cushions while the system is arranged in the primary configuration.
